(19) United States
(12) Patent Application Publication
(10) Pub. No.: US 2020/0057458 A1
(43) Pub. Date: Feb. 20, 2020

(54) CONTROL VALVE FOR VARIABLE DISPLACEMENT COMPRESSOR

(71) Applicant: SANDEN AUTOMOTIVE COMPONENTS CORPORATION, Isesaki-shi, Gunma (JP)

(72) Inventor: Yukihiko TAGUCHI, Isesaki-shi, Gunma (JP)

(21) Appl. No.: 16/342,932

(22) PCT Filed: Sep. 7, 2017
(86) PCT No.: PCT/JP2017/033173

§ 371 Date: Apr. 17, 2019

(30) Foreign Application Priority Data
Oct. 18, 2016 (JP) 2016-204401

(51) Int. Cl. G05D 16/20; F16K 31/06

(52) U.S. Cl. CPC G05D 16/2022; F16K 31/06

(57) ABSTRACT

A control valve of a variable displacement compressor capable of preventing a decrease in control accuracy is provided. In a control valve 300, a valve chamber 321b accommodating a valve body 322 constitutes a part of a pressure supply passage for supplying refrigerant in a discharge chamber to a crank chamber, or constitutes a part of a pressure relief passage through which refrigerant in the crank chamber flows toward a suction chamber, depending on whether the valve hole 321c is open or closed by a valve portion 322a of the valve body 322. A partition portion 322b having a larger diameter than that of the valve portion 322a of the valve body 322, partitions the valve chamber 321b into a first pressure application chamber 321b1 on which the pressure in the suction chamber mainly acts, and a second pressure application chamber 321b2 on which the pressure in the crank chamber mainly acts and into which refrigerant in the discharge chamber flows when the valve hole 321c is open. A clearance between an outer peripheral surface of the partition portion 322b and an inner peripheral surface of the valve chamber 321b forms a fixed orifice of the pressure relief passage. The second pressure application chamber 321b2 is formed to have a larger inner diameter than that of the inner peripheral surface of the valve chamber 321b.

### TECHNICAL FIELD

The present invention relates to control valves for use in variable displacement compressors.

### BACKGROUND ART

An example of a control valve of this type is disclosed in Patent Document 1. A control valve (displacement control valve) 31 disclosed in Patent Document 1 is arranged along a discharge pressure supply passage that provides communication between a discharge chamber 64 and a crank chamber 55 of a variable displacement compressor. The control valve 31 includes a valve body 9 having a valve portion 11 that opens and closes a valve hole formed in the discharge pressure supply passage, a valve chamber 12 in which the valve portion 11 is disposed and on which the pressure in the crank chamber 55 acts, a partition 32 secured to the valve body 9, and a pressure chamber 17 partitioned from the valve chamber 12 by the partition 32 and being configured so that the pressure in the suction chamber 65 acts on the pressure chamber 17. Furthermore, in the control valve 31, a clearance 34 between an outer peripheral surface of the partition 32 and an inner peripheral surface of the valve chamber 12 forms a fixed orifice of a pressure relief passage that provides communication between the crank chamber 55 and the suction chamber 65.

### REFERENCE DOCUMENT LIST

### Patent Document

Patent Document 1: JP 2003-301772 A

### SUMMARY OF THE INVENTION

### Problem to be Solved by the Invention

In the conventional control valve 31, when the valve portion 11 opens the valve hole, a refrigerant in the discharge chamber 64 flows into the valve chamber 12 through the valve hole. At this time, since the partition 32 is formed to have a larger diameter than that of the valve body 9, the refrigerant flowing into the valve chamber 12 directly collides with a surface of the partition wall 32 on a side of the valve chamber 12 (valve hole), so that a force in a direction in which the valve hole opens (valve opening direction) acts on the valve body 9. Furthermore, the force in the valve opening direction due to the refrigerant flowing into the valve chamber 12 widely varies depending on the flow rate of the refrigerant, or the like. Thus, there is a concern that when the opening degree of the valve hole is greatly changed, the opening degree of the valve hole may deviate from a desired opening degree (that is, the control accuracy of the control valve 31 may decrease).

Thus, an object of the present invention is to provide a control valve for a variable displacement compressor, capable of preventing the control accuracy from being reduced.

### Means for Solving the Problem

According to an aspect of the present invention, there is provided a control valve for a variable displacement compressor, for use to adjust a pressure in a controlled pressure chamber in the variable displacement compressor that includes a suction chamber into which a refrigerant, before being compressed, is introduced, a compression section that draws and compresses the refrigerant in the suction chamber, a discharge chamber into which the compressed refrigerant compressed by the compression section is discharged, and the controlled pressure chamber, in which a state of the compression section changes in accordance with a pressure in the controlled pressure chamber to change a discharge displacement. The control valve comprising: a valve body having a valve portion that adjusts an opening degree of a valve hole constituting a part of a pressure supply passage for supplying the refrigerant in the discharge chamber to the controlled pressure chamber; and a valve chamber that accommodates the valve body, the valve chamber consisting a part of a pressure relief passage through which the refrigerant in the controlled pressure chamber flows toward the suction chamber when the valve portion of the valve body closes the valve hole, and consisting a part of the pressure supply passage when the valve portion of the valve body opens the valve hole. The valve body further has a partition portion having a larger diameter than that of the valve portion and partitioning the valve chamber into a first pressure application chamber on which a pressure in the suction chamber mainly acts, and a second pressure application chamber on which the pressure in the controlled pressure chamber mainly acts and into which the refrigerant in the discharge chamber flows when the valve portion of the valve body opens the valve hole. A clearance constituting a fixed orifice of the pressure relief passage is formed between an outer peripheral surface of the partition portion of the valve body and an inner peripheral surface of the valve chamber facing the outer peripheral surface, and the second pressure application chamber is formed to have a larger inner diameter than that of the inner peripheral surface of the valve chamber facing the outer peripheral surface of the partition portion of the valve body.

### Effects of the Invention

In the control valve of the variable displacement compressor, the second pressure application chamber of the valve chamber, into which the refrigerant in the discharge chamber flows when the valve portion of the valve body opens the valve hole, is formed to have a larger inner diameter than that of the inner peripheral surface of the valve chamber facing the outer peripheral surface of the partition portion of the valve body. Thus, the refrigerant flowing into the valve chamber is prevented from directly colliding with a valve hole-side surface of the partition wall of the valve body. Thus, it is possible to prevent the control accuracy of the control valve from being reduced due to the dynamic pressure of the refrigerant flow flowing into the valve chamber, and to stably control the control valve as compared with a conventional technique.

### BRIEF DESCRIPTION OF THE DRAWINGS

FIG. 1 is a cross-sectional view illustrating a schematic configuration of a variable displacement compressor to which the present invention is applied.

FIG. 2 is a cross-sectional view illustrating a configuration of a first embodiment of a control valve of the variable displacement compressor.

FIG. 3 is an enlarged cross-sectional view of the main part of a valve chamber and a valve body of the control valve.

FIG. 4 is a view illustrating the main part of a second embodiment of the control valve.

FIG. 5 is a view illustrating a modified example of the second embodiment of the control valve.

FIG. 6 is a view illustrating a modified example of the second embodiment of the control valve.

FIG. 7 is a view illustrating a modified example of the second embodiment of the control valve.

FIG. 8 is a view illustrating a modified example of the second embodiment of the control valve.

FIG. 9 is a view illustrating a modified example of the second embodiment of the control valve.

FIG. 10 is a view illustrating the main part of a third embodiment of the control valve.

FIG. 11 is a view illustrating a modified example of the third embodiment of the control valve.

FIG. 12 is a view illustrating the main part of a fourth embodiment of the control valve.

FIG. 13 is a view that also illustrates the main part of the fourth embodiment of the control valve.

### MODE FOR CARRYING OUT THE INVENTION

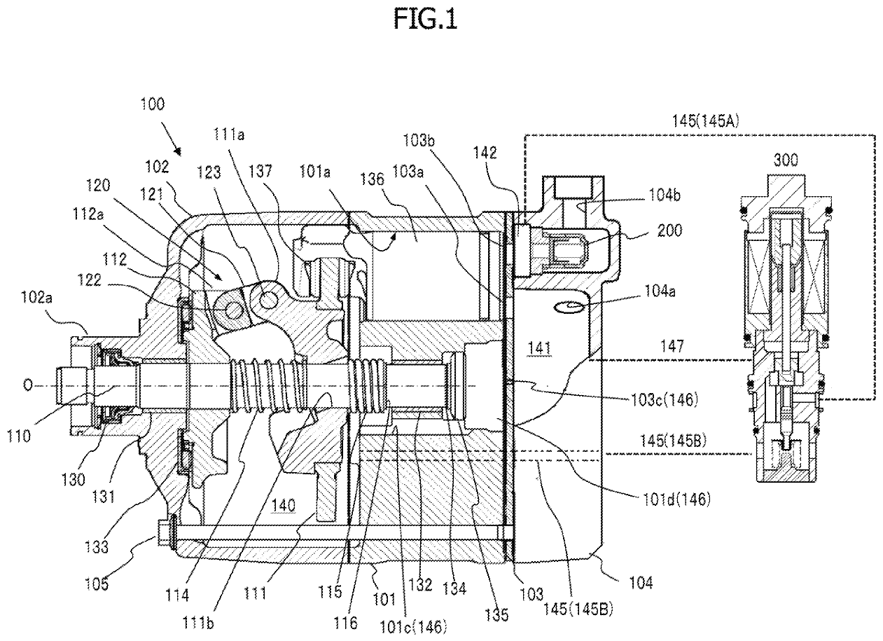

Hereinbelow, embodiments of the present invention will be described with reference to the accompanying drawings. FIG. 1 is a cross-sectional view illustrating a schematic configuration of a swash plate type variable displacement compressor to which the present invention is applied. This variable displacement compressor is configured as a clutch-less compressor mainly applied to air conditioning systems for vehicles.

A variable displacement compressor 100 includes: a cylinder block 101 in which multiple cylinder bores 101a are formed; a front housing 102 provided on one end of the cylinder block 101; and a cylinder head 104 provided on the other end of the cylinder block 101 via a valve plate 103. The cylinder block 101, the front housing 102, the valve plate 103 and the cylinder head 104 are fastened by multiple through bolts 105 to constitute a compressor housing. The cylinder block 101 and the front housing 102 form a crank chamber 140, and a drive shaft 110 rotatably supported by the compressor housing is provided so as to traverse the inside of the crank chamber 140. Although not illustrated in the drawings, a center gasket is arranged between the front housing 102 and the cylinder block 101, and a cylinder gasket, a suction valve forming plate, a discharge valve forming plate and a head gasket are arranged between the cylinder block 101 and the cylinder head 104, in addition to the valve plate 103.

A swash plate 111 is disposed around an axially intermediate portion of the drive shaft 110. The swash plate 111 is coupled, via a linkage 120, to a rotor 112 secured to the drive shaft 110, and rotates with the drive shaft 110. The swash plate 111 is configured so that the angle (inclination angle) thereof with respect to the axis O of the drive shaft 110 is changeable.

The linkage 120 includes: a first arm 112a protruding from the rotor 112; a second arm 111a protruding from the swash plate 111; and a link arm 121 having one end rotatably connected to the first arm 112a via a first connecting pin 122, and the other end rotatably connected to the second arm 111a via a second connecting pin 123.

A through hole 111b of the swash plate 111, through which the drive shaft 110 is inserted, is formed in such a shape that the swash plate 111 is capable of inclining within a range between a maximum inclination angle and a minimum inclination angle. In the through hole 111b, a minimum inclination angle regulating portion that is adapted to contact the drive shaft 110, is formed. In a case in which the inclination angle of the swash plate 111, when the swash plate 111 is orthogonal to the axis O of the drive shaft 110 (i.e., the minimum inclination angle) is 0°, the minimum inclination angle regulating portion of the through hole 111b is formed such that the minimum inclination angle regulating portion contacts the drive shaft 110, when the inclination angle of the swash plate 111 is substantially 0°, to regulate further inclination of the swash plate 111. In addition, when the inclination angle of the swash plate 111 reaches the maximum inclination angle, the swash plate 111 contacts the rotor 112 so that further inclining motion is restricted.

On the drive shaft 110, there are fitted an inclination angle decreasing spring 114 that urges the swash plate 111 in a direction in which the inclination angle of the swash plate 111 decreases, and an inclination angle increasing spring 115 that urges the swash plate 111 in a direction in which the inclination angle of the swash plate 111 increases. The inclination angle decreasing spring 114 is arranged between the swash plate 111 and the rotor 112, and the inclination angle increasing spring 115 is fitted between the swash plate 111 and a spring support member 116 secured to the drive shaft 110.

When the inclination angle of the swash plate 111 is the minimum inclination angle, the biasing force of the inclination angle increasing spring 115 is set to be greater than that of the inclination angle decreasing spring 114. Accordingly, when the drive shaft 110 is not rotating, the swash plate 111 is positioned at an inclination angle at which the biasing force of the inclination angle decreasing spring 114 and that of the inclination angle increasing spring 115 are balanced.

One end (the left end in FIG. 1) of the drive shaft 110 extends through a boss 102a of the front housing 102 to the outside of the front housing 102. A power transmission device (not illustrated) is connected to the one end of the drive shaft 110. A shaft sealing device 130 is arranged between the drive shaft 110 and the boss 102a, and the interior of the crank chamber 140 is isolated from the exterior.

A coupled body of the drive shaft 110 and the rotor 112 is supported by bearings 131 and 132 in the radial direction, and is supported by a bearing 133 and a thrust plate 134 in the thrust direction. The drive shaft 110 (and the rotor 112) is configured to be rotated in synchronization with the rotation of the power transmission device by the power from the external drive source transmitted to the power transmission device. A clearance between the other end of the drive shaft 110, that is, the end on a thrust plate 134 side, and the thrust plate 134, is adjusted to a predetermined distance by an adjust screw 135.

In each cylinder bore 101a, a piston 136 is disposed. An inner space formed in a protruding portion of the piston 136 protruding into the crank chamber 140, accommodates an outer peripheral portion of the swash plate 111 and the vicinity thereof. The swash plate 111 is configured to work together with the piston 136 via a pair of shoes 137. Thus, the piston 136 reciprocates in the cylinder bore 101a as the swash plate 111 rotates in accordance with the rotation of the drive shaft 110. That is, rotational motion of the drive shaft 110 is converted into reciprocating motion of the piston 136 by a conversion mechanism including the swash plate 111, the linkage 120, the pair of shoes 137, and the like.

In the cylinder head 104, there are formed a suction chamber 141 arranged substantially at the center, and a discharge chamber 142 annularly surrounding the suction chamber 141. The suction chamber 141 communicates with the cylinder bore 101a through a communication hole 103a provided in the valve plate 103 and a suction valve (not illustrated) formed in the suction valve forming plate (not illustrated). The discharge chamber 142 communicates with the cylinder bore 101a through a discharge valve (not illustrated) formed in the discharge valve forming plate (not illustrated) and a communication hole 103b provided in the valve plate 103.

In the cylinder head 104, a suction passage 104a and a discharge passage 104b are formed. One end of the suction passage 104a is open to the suction chamber 141, and the other end of the suction passage 104a is connected to a low-pressure side of a refrigerant circuit of the air conditioning system (not illustrated). One end of the discharge passage 104b is open to the discharge chamber 142, and the other end of the discharge passage 104b is connected to a high-pressure side of the refrigerant circuit of the air conditioning system (not illustrated).

A refrigerant at the low-pressure side (refrigerant before being compressed) of the refrigerant circuit of the air conditioning system is introduced into the suction chamber 141 through the suction passage 104a. The refrigerant in the suction chamber 141 is drawn into the cylinder bore 101a by the reciprocating motion of the piston 136, and then, is compressed and discharged into the discharge chamber 142. That is, in the present embodiment, a compression section that compresses the refrigerant in the suction chamber 141 is constituted by the cylinder bore 101a and the piston 136. The refrigerant (compressed refrigerant) discharged into the discharge chamber 142 is introduced into the refrigerant circuit on the high-pressure side of the air conditioning system through the discharge passage 104b.

In the discharge passage 104b, there is provided a check valve 200 that prevents a backward flow of the refrigerant flowing from the high-pressure side of the refrigerant circuit of the air conditioning system toward the discharge chamber 142. The check valve 200 is configured to operate in response to a pressure difference between the upstream side and the downstream side thereof, that is specifically a pressure difference between the discharge chamber 142 (at the upstream side of the check valve 200) and the high-pressure side of the refrigerant circuit of the air conditioning system (at the downstream side of the check valve 200), so that the check valve 200 blocks the discharge passage 104b when the pressure difference is less than a predetermined value, and opens the discharge passage 104b when the pressure difference is greater than or equal to the predetermined value.

The cylinder head 104 is further provided with a control valve 300. The control valve 300 is disposed in a valve accommodation chamber (not illustrated) formed in the cylinder head 104. The valve accommodation chamber constitutes a part of a pressure supply passage 145 that provides communication between the discharge chamber 142 and the crank chamber 140, and that supplies the refrigerant (discharged refrigerant) in the discharge chamber 142 to the crank chamber 140. The control valve 300 is configured to adjust the opening degree (passage cross-sectional area) of the pressure supply passage 145, so as to control the supply amount (pressure supply amount) of the refrigerant (discharged refrigerant) in the discharge chamber 142 to the crank chamber 140.

By adjusting the opening degree of the pressure supply passage 145 by the control valve 300, it is possible to change (i.e., increase or decrease) the pressure in the crank chamber 140, so as to decrease or increase the inclination angle of the swash plate 111, that is, the stroke of the piston 136, to thereby change the discharge displacement of the variable displacement compressor 100. That is, the variable displacement compressor 100 is configured so that the state of the compression section (specifically, the stroke of the piston 136) changes in accordance with the pressure in the crank chamber 140, to change the discharge displacement. In other words, in the variable displacement compressor 100, the crack chamber 140 changes the state of the compression section in accordance with the internal pressure, to change the discharge displacement. The control valve 300 is primarily used to adjust the pressure in the crank chamber 140. Thus, in the present embodiment, the crank chamber 140 corresponds to a “controlled pressure chamber” of the present invention.

Specifically, by changing the pressure in the crank chamber 140, it is possible to change the inclination angle of the swash plate 111 by utilizing the pressure difference between the front side and rear side of each piston 136, that is, the pressure difference between a compression chamber in the cylinder bore 101a and the crank chamber 140, which are on the both sides across the piston 136, so that the stroke amount of the piston 136 changes, so as to change the discharge displacement of the variable displacement compressor 100. Specifically, when the pressure in the crank chamber 140 is decreased, the inclination angle of the swash plate 111 increases, so that the stroke amount of the piston 136 increases, and accordingly, the discharge displacement of the variable displacement compressor 100 increases.

The crank chamber 140 communicates with the suction chamber 141 through a pressure relief passage 146 including a communication passage 101c and a space 101d formed in the cylinder block 101, and a fixed throttle 103c formed in the valve plate 103. The refrigerant in the crank chamber 140 flows into the suction chamber 141 through the pressure relief passage 146.

In the present embodiment, the control valve 300 receives a signal from a control device (not illustrated) provided outside the variable displacement compressor 100, and the pressure in the suction chamber 141 is introduced into the control valve 300 through a pressure introduction passage 147. The control valve 300 is basically configured to adjust the opening degree of the pressure supply passage 145 in a manner such that the pressure in the suction chamber 141 becomes a pressure set by the signal based on air-conditioning setting (cabin set temperature), the external environment, or the like. The discharge displacement of the variable displacement compressor 100 changes along with the opening degree of the pressure supply passage 145 adjusted by the control valve 300.

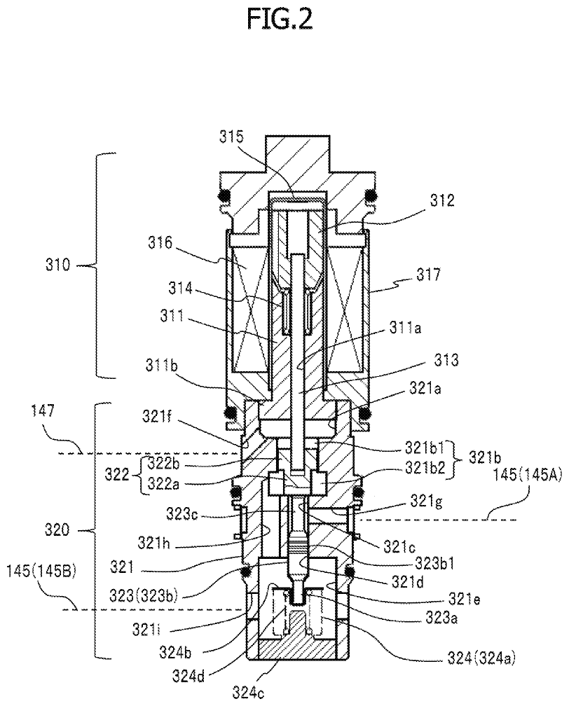

Next, a first embodiment of the control valve 300 will be described with reference to FIG. 2. In the following description, for the sake of convenience of explanation, a portion of the pressure supply passage 145 from the discharge chamber 142 to the control valve 300 is defined as a pressure supply passage 145A, and a portion of the pressure supply passage 145 from the control valve 300 to the crank chamber 140 is defined as a pressure supply passage 145B.

As illustrated in FIG. 2, the control valve 300 includes a solenoid unit 310 and a valve unit 320.

The solenoid unit 310 includes: a fixed core 311 in which a through hole 311a is formed, the through hole 311a extending from one end face to the other end face of the fixed core 311; a movable core 312 arranged with a clearance from the one end face of the fixed core 311; a solenoid rod 313 integrally connected to the movable core 312 and inserted through the through hole 311a with a clearance; a compression coil spring 314 that urges the movable core 312 in a direction departing from the fixed core 311; an accommodation member 315 that accommodates the fixed core 311 and the movable core 312, the accommodation member 315 being formed in a tubular shape with a bottom; a coil 316 arranged to surround the accommodation member 315 and covered with resin; a solenoid housing 317 that accommodates the coil 316 and holds the accommodation member 315. In the present embodiment, an end portion of the fixed core 311 opposite to the movable core 312 is formed as a larger diameter portion 311b having a larger diameter than that of the other portion.

A tip of the solenoid rod 313 is connected to a valve body 322 (described below) of the valve unit 320. The accommodation member 315 is formed of a non-magnetic material. The fixed core 311, the movable core 312, and the solenoid housing 317, are made of a magnetic material and form a magnetic circuit. When the coil 316 is energized, the solenoid unit 310 generates an electromagnetic force that moves the movable core 312 toward the fixed core 311 against the biasing force of the compression coil spring 314. Then, the movement of the movable core 312 toward the fixed core 311 transmits to the valve body 322 of the valve unit 320 via the solenoid rod 313, so that the valve body 322 moves in a valve closing direction. That is, the solenoid unit 310 is configured to apply the electromagnetic force in the valve closing direction to the valve body 322. The valve closing direction is a direction in which a valve portion 322a of the valve body 322 closes a valve hole 321c, as will be described below.

The valve unit 320 includes: a valve housing 321; the valve body 322 to which the tip of the solenoid rod 313 is connected at one end side thereof; a pressure sensing rod 323 formed integrally with the valve body 322 and extending from the other end side of the valve body 322; and a pressure sensing member 324 that contacts a tip of the pressure sensing rod 323, and that expands and contracts in response to the pressure in the suction chamber 141 to drive the valve body 322 via the pressure sensing rod 323.

In the valve housing 321, there are formed, on the same axis, a fitting hole 321a in which the larger diameter portion 311b of the fixed core 311 of the solenoid unit 310 fits, a valve chamber 321b that accommodates the valve body 322, the valve hole 321c that is opened and closed by the valve body 322, an insertion hole 321d through which the pressure sensing rod 323 is inserted so as to support the pressure sensing rod 323, and a pressure sensing chamber 321e that accommodates the pressure sensing member 324, in this order, from a side of the solenoid unit 310. In the valve housing 321, there are formed a communication hole 321f that provides communication between the fitting hole 321a and the pressure introduction passage 147, a communication hole 321g that provides communication between the pressure supply passage 145A and the valve hole 321c, a communication hole 321h that provides communication between the valve chamber 321b and the pressure sensing chamber 321e, and a communication hole 321i that provides communication between the pressure sensing chamber 321e and the pressure supply passage 145B.

An opening end of the fitting hole 321a is closed by fitting the larger diameter portion 311b of the fixed core 311. The fitting hole 321a communicates with the suction chamber 141 through the communication hole 321f and the pressure introduction passage 147.

The valve chamber 321b has an opening that is open at the bottom of the fitting hole 321a, and communicates with the fitting hole 321a through the opening. The valve hole 321c has one end that is open to the valve chamber 321b, and has the other end that communicates with the discharge chamber 142 through the communication hole 321g and the pressure supply passage 145A. Specifically, in the present embodiment, the valve chamber 321b is constituted by a smaller diameter chamber having a first cylindrical space and a larger diameter chamber having a second cylindrical space larger in diameter than the first cylindrical space. The smaller diameter chamber is arranged to be closer to the fitting hole 321a, and the one end of the valve hole 321c is open to the larger diameter chamber.

One end of the insertion hole 321d is connected to the other end of the valve hole 321c, and the other end of the insertion hole 321d is open to the pressure sensing chamber 321e. The pressure sensing chamber 321e communicates with the valve chamber 321b through the communication hole 321h, and communicates with the crank chamber 140 through the communication hole 321i and the pressure supply passage 145B. In the present embodiment, the communication hole 321h is formed to be substantially parallel to the insertion hole 321d and arranged radially outward of the insertion hole 321d.

Although each of the communication holes 321f to 321i is indicated as a single hole in the figure, all or some of the communication holes 321f to 321i may be formed to be multiple.

In other words, in the valve housing 321, there are formed a first internal passage connecting the discharge chamber 142 (pressure supply passage 145A) and the crank chamber 140 (pressure supply passage 145B), and a second internal passage connecting a crank chamber 140 (pressure supply passage 145B) and the suction chamber 141 (pressure introduction passage 147). The first internal passage is constituted by the communication hole 321g, the valve hole 321c, the valve chamber 321b, the communication hole 321h, the pressure sensing chamber 321e, and the communication hole 321i. The second internal passage is constituted by the communication hole 321i, the pressure sensing chamber 321e, the communication hole 321h, the valve chamber 321b, the fitting hole 321a, and the communication hole 321f.

The valve body 322 has the valve portion 322a that adjusts the opening degree of the valve hole 321c, and a partition portion 322b formed to have a larger diameter than that of the valve portion 322a. The partition portion 322b is disposed in the smaller diameter chamber of the valve chamber 321b, and partitions the valve chamber 321b into a first pressure application chamber 321b1 on which the pressure in the suction chamber 141 mainly acts, the first pressure application chamber 321b1 being located on a side of the fitting hole 321a, and a second pressure application chamber 321b2 on which the pressure in the crank chamber 140 mainly acts, the second pressure application chamber 321b2 being located on a side of the valve hole 321c. Thus, the valve portion 322a is disposed in the second pressure application chamber 321b2.

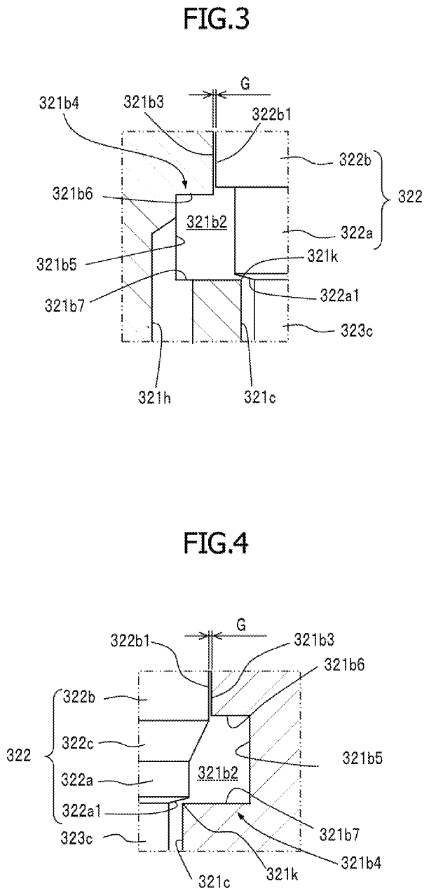

FIG. 3 is an enlarged cross-sectional view of the main part of the valve chamber 321b and the valve body 322. In the present embodiment, a predetermined clearance G is formed between an outer peripheral surface 322b1 of the partition portion 322b of the valve body 322 and an inner peripheral surface 321b3 of the valve chamber 321b (the smaller diameter chamber of the valve chamber 321b), facing the outer peripheral surface 322b1. That is, the first pressure application chamber 321b1 and the second pressure application chamber 321b2 communicate through the clearance G.

The second pressure application chamber 321b2 is formed to have a larger inner diameter than that of the inner peripheral surface 321b3 facing the outer peripheral surface 322b1 of the partition portion 322b. In other words, the second pressure application chamber 321b2 has a recess 321b4 recessed radially outward with respect to the inner peripheral surface 321b3 facing the outer peripheral surface 322b1 of the partition portion 322b. In the present embodiment, the recess 321b4 of the second pressure application chamber 321b2 is formed in a shape of a rectangular groove, and is constituted by: a bottom surface 321b5 corresponding to the inner peripheral surface of the second pressure application chamber 321b2; a connecting surface 321b6 connecting the bottom surface 321b5 and the inner peripheral surface 321b3 of the valve chamber 321b facing the outer peripheral surface 322b1 of the partition portion 322b; and an extending surface 321b7 extending from an end face of the valve chamber 321b at which one end of the valve hole 321c is open.

The communication hole 321h providing communication between the valve chamber 321b and the pressure sensing chamber 321e has, on a valve chamber 321b side, an opening end that is open to a region in the second pressure application chamber 321b2, the region being radially outward the inner peripheral surface 321b3 of the valve chamber 321b facing the outer peripheral surface 322b1 of the partition portion 322b of the valve body 322 (that is, the recess 321b4).

In the present embodiment, an inclined surface 322a1 is formed at a tip of the valve portion 322a of the valve body 322. The valve hole 321c is closed by the inclined surface 322a1 contacting an edge 321k of the valve hole 321c. That is, in the present embodiment, the edge 321k of the valve hole 321c constitutes a valve seat that contacts the valve portion 322a of the valve body 322, and the valve portion 322a contacts the valve seat (edge 321k) in a line contact manner.

Returning to FIG. 2, the pressure sensing rod 323 has: a tip portion 323a that contacts and departs from one end of the pressure sensing member 324; a support portion 323b formed to have a larger diameter than that of the tip portion 323a, and inserted and supported by the insertion hole 321d; a connection portion 323c that connects the support portion 323b and the valve body 322, the connection portion 323c being disposed in the valve hole 321c and having a smaller diameter than that of the support portion 323b. A clearance between the outer peripheral surface of the support portion 323b and the inner peripheral surface of the insertion hole 321d is set as a minute clearance so that the valve hole 321c and the pressure sensing chamber 321e are substantially partitioned. Preferably, an annular groove 323b1 for providing a labyrinth seal may be formed on the outer peripheral surface of the support portion 323b.

The pressure sensing member 324 includes: a bellows 324a that expands and contracts in a moving direction of the valve body 322; a first end member 324b that closes one end of the bellows 324a and receives the tip portion 323a of the pressure sensing rod 323; a second end member 324c that closes the other end of the bellows 324a and is fitted and secured to the valve housing 321 to partition the pressure sensing chamber 321e; and a compression coil spring 324d disposed in the bellows 324a and urges the bellows 324a in an expanding direction of the bellows 324a.

Then, the solenoid unit 310 and the valve unit 320 are fitted and secured to each other and integrated, to provide the control valve 300.

In the control valve 300, the pressure sensing rod 323, the valve body 322, the solenoid rod 313, and the movable core 312 form an integrated structure. The integrated structure including the pressure sensing rod 323, the valve body 322, the solenoid rod 313, and the movable core 312 is configured so that the support portion 323b of the pressure sensing rod 323 is slidably supported by the insertion hole 321d on one end side of the integrated structure, and the outer peripheral surface of the movable core 312 is slidably supported by the inner peripheral surface of the accommodation member 315 on the other end side of the integrated structure, so that the integrated structure is movable in the axial direction. Here, in the present embodiment, the integrated structure is configured so that, in a space formed by the valve hole 321c and the insertion hole 321d, the pressure supplied from the discharge chamber 142 acting on a surface on the upper side and that acting on a surface on the lower side in the axial direction are offset, since the surfaces have substantially the same area. Furthermore, the cross-sectional area of the partition portion 322b defined by the outer diameter of the partition portion 322b and a pressure receiving area of the bellows 324a receiving pressure in the expanding and contracting direction are set to be substantially the same. Thus, when the pressure sensing member 324 is connected to the integrated structure, in the pressure sensing chamber 321e and the second pressure application chamber 321b2, the pressure supplied from the crank chamber 140 acting on a surface on the upper side and that acting on a surface on the lower side in the axial direction of the connected body of the integrated structure and the pressure sensing member 324 are offset, since the areas of the surfaces are set to be substantially the same. That is, the pressure sensing member 324 is configured to expand and contract in accordance with the pressure from the suction chamber 141 acting on the surface of the partition portion 322b on a side of the first pressure application chamber 321b1. Thus, the valve body 322 are controlled to be opened and closed substantially in accordance with the electromagnetic force in the valve closing direction generated by the solenoid unit 310 and the pressure from the suction chamber 141 acting on the pressure sensing member 324 via the integrated structure. In the pressure sensing member 324, the bellows 324a expands as the pressure in the suction chamber 141 decreases, so that the biasing force in the valve opening direction (that is, the direction in which the valve portion 322a opens the valve hole 321c) acts on the valve body 322 via the pressure sensing rod 323.

In the control valve 300, the first internal passage (communication hole 321g, valve hole 321c, valve chamber 321b, communication hole 321h, pressure sensing chamber 321e and communication hole 321i) of the valve housing 321 provides communication between the discharge chamber 142 (pressure supply passage 145A) and the crank chamber 140 (pressure supply passage 145B), when the valve portion 322a of the valve body 322 opens the valve hole 321c, whereas the communication between the discharge chamber 142 (pressure supply passage 145A) and the crank chamber 140 (pressure supply passage 145B) is blocked, when the valve portion 322a of the valve body 322 closes the valve hole 321c. By opening the valve hole 321c by the valve portion 322a of the valve body 322, the refrigerant (discharged refrigerant) in the discharge chamber 142 is supplied to the crank chamber 140, and the pressure in the crank chamber 140 increases. Thus, the valve hole 321c constitutes a part of the pressure supply passage 145, and a part of the first internal passage located downstream the valve hole 321c, that is specifically the valve chamber 321b, the communication hole 321h, the pressure sensing chamber 321e and the communication hole 321i, constitutes a part of the pressure supply passage 145, when the valve portion 322a of the valve body 322 opens the valve hole 321c.

Furthermore, in the control valve 300, the second internal passage (communication hole 321i, pressure sensing chamber 321e, communication hole 321h, valve chamber 321b (clearance G), fitting hole 321a and communication hole 321f) of the valve housing 321 provides communication between the crank chamber 140 (pressure supply passage 145B) and the suction chamber 141 (pressure introduction passage 147). When the valve portion 322a of the valve body 322 closes the valve hole 321c, the refrigerant in the crank chamber 140 flows through the second internal passage toward the suction chamber 141. That is, the second internal passage of the valve housing 321 constitutes a part of a second pressure relief passage, which is different from the pressure relief passage 146 described above. In the valve chamber 321b, the clearance G formed between the outer peripheral surface 322b1 of the partition portion 322b of the valve body 322 and the inner peripheral surface 321b3 of the valve chamber 321b facing the outer peripheral surface 322b1 constitutes a fixed throttle (fixed orifice) of the second pressure relief passage. The channel cross-sectional area defined by the clearance G is preferably set to be equal to or smaller than that of the fixed throttle 103c of the pressure relief passage 146.

Next, the operation of the control valve 300 will be described.

When the air conditioning system is in operation, that is, when the variable displacement compressor 100 is in an operating state, the control device performs a PWM control at a predetermined frequency in a range of 400 to 500 Hz, for example, based on air-conditioning setting (cabin set temperature), the external environment, or the like, to control a power supply amount of the coil 316 of control valve 300. Then, the control valve 300 adjusts the opening degree of the valve hole 321c (that is, the pressure supply passage 145) by the valve portion 322a of the valve body 322 so that the pressure in the suction chamber 141 becomes a set pressure corresponding to the power supply amount of the coil 316, to control the discharge displacement of the variable displacement compressor 100.

When the valve portion 322a of the valve body 322 opens the valve hole 321c, a part of the refrigerant (discharged refrigerant) in the discharge chamber 142 flows, in accordance with the opening degree of the valve hole 321c, through the pressure supply passage 145A, the communication hole 321g and the valve hole 321c, and then flows into the second pressure application chamber 321b2 of the valve chamber 321b. Here, in the present embodiment, the second pressure application chamber 321b2 is formed to have a larger inner diameter than that of the inner peripheral surface 321b3 of the valve chamber 321b facing the outer peripheral surface 322b1 of the partition portion 322b of the valve body 322. Thus, the discharged refrigerant flowing into the second pressure application chamber 321b2 of the valve chamber 321b is prevented from colliding with the surface of the valve body 322 of the partition portion 322b on a side of the valve hole 321c. In particular, in the present embodiment, the discharged refrigerant passes through a space formed between the tip of the valve portion 322a (inclined surface 322a1) and the edge 321k of the valve hole 321c, and flows into the second pressure application chamber 321b2 of the valve chamber 321b. Thus, the discharged refrigerant spreads radially when flowing into the second pressure application chamber 321b2, and most of the discharged refrigerant flowing into the second pressure application chamber 321b2 of the valve chamber 321b collides with an inner surface of the second pressure application chamber 321b2 (specifically, the bottom surface 321b5 of the recess 321b4 and the connecting surface 321b6), and hardly collides with the surface of the partition portion 322b of the valve body 322 on the valve hole 321c side. Thus, the dynamic pressure of the refrigerant flow flowing into the valve chamber 321b (second pressure application chamber 321b2) is prevented from acting in the valve opening direction of the valve body 322, so that it is possible to prevent a decrease in control accuracy of the control valve 300.

The discharged refrigerant which has flowed into the second pressure application chamber 321b2 of the valve chamber 321b then flows (or is supplied) to the crank chamber 140 through the communication hole 321h, the pressure sensing chamber 321e, the communication hole 321i, and the pressure supply passage 145B. This increases the pressure in the crank chamber 140. In the present embodiment, the opening end of the communication hole 321h on a valve chamber 321b side is open to the recess 321b4 of the second pressure application chamber 321b2, that is, to the region radially outward the inner peripheral surface 321b3 of the valve chamber 321b facing the outer peripheral surface 322b1 of the partition portion 322b of the valve body 322. Thus, as described above, it is possible for the discharged refrigerant that has flowed into the second pressure application chamber 321b2 and has spread radially, to smoothly flow into the communication hole 321h, and to be supplied to the crank chamber 140 via the pressure sensing chamber 321e and the pressure supply passage 145B. Here, by arranging multiple communication holes 321h at intervals in the circumferential direction, it is possible to supply the discharged refrigerant to the crank chamber 140 more smoothly. It should be noted that a part of the discharged refrigerant which has flowed into the second pressure application chamber 321b2 of the valve chamber 321b may flow through the clearance G, the fitting hole 321a, the communication hole 321f, and the pressure introduction passage 147 and then flow into the suction chamber 141.

On the other hand, when the valve portion 322a of the valve body 322 closes the valve hole 321c, the supply of the refrigerant in the discharge chamber 142 to the crank chamber 140 stops, and, in accordance with the pressure difference between the crank chamber 140 and the suction chamber 141, the refrigerant in the crank chamber 140 flows through the pressure supply passage 145B, the communication hole 321i, the pressure sensing chamber 321e, the communication hole 321h, the valve chamber 321b (clearance G), the fitting hole 321a, the communication hole 321f and the pressure introduction passage 147, and then flows into the suction chamber 141.

When the operation of the air conditioning system stops, that is, when the variable displacement compressor 100 is switched from the operating state to an inactive state, the control device turns off the energization of the coil 316 of the control valve 300. Then, the integrated structure including the pressure sensing rod 323, the valve body 322, the solenoid rod 313 and the movable core 312 is moved by the biasing force of the compression coil spring 314 in a direction in which the valve portion 322a of the valve body 322 opens the valve hole 321c, so that the valve hole 321c opens to a maximum. This causes the refrigerant (discharged refrigerant) in the discharge chamber 142 to be supplied to the crank chamber 140, resulting in an increase in pressure in the crank chamber 140. As a result, the inclination angle of the swash plate 111 decreases, the stroke of the piston 136 decreases, and the discharge displacement of the variable displacement compressor 100 becomes minimum. During the inactive state of the variable displacement compressor 100, the discharge displacement is maintained in the minimum state.

Next, a second embodiment of the control valve 300 will be described with reference to FIG. 4. The same elements as those of the first embodiment are denoted by the same reference symbols, and different elements will be mainly described.

In the second embodiment, the valve body 322 has a tapered face 322c having the diameter increasing from the valve portion 322a to the partition portion 322b. The tapered face 322c is formed, for example, as a conical surface centered on the axis of the valve body 322. Preferably, the tapered face 322c may be formed such that an end portion thereof on a side of the partition portion 322b is located in the second pressure application chamber 321b2 (in other words, a part of the partition portion 322b on a side of the valve portion 322a is located in the second pressure application chamber 321b2). In this way, the refrigerant that has flowed into the second pressure application chamber 321b2 of the valve chamber 321b flows along the tapered face 322c and collides with an inner wall surface (mainly the connecting surface 321b6 of the recess 321b4) of the second pressure application chamber 321b2. Thus, it is possible to more effectively prevent the dynamic pressure of the refrigerant flow flowing into the valve chamber 321b (second pressure application chamber 321b2) from acting in the valve opening direction of the valve body 322. The tapered face 322c may be formed as a curved surface.

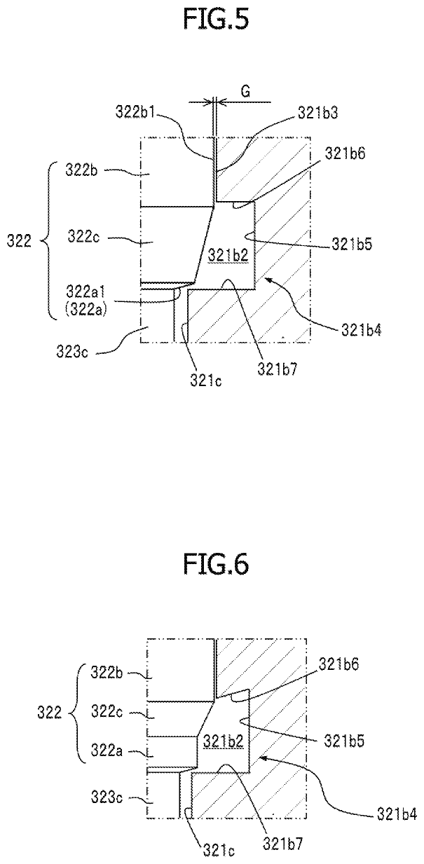

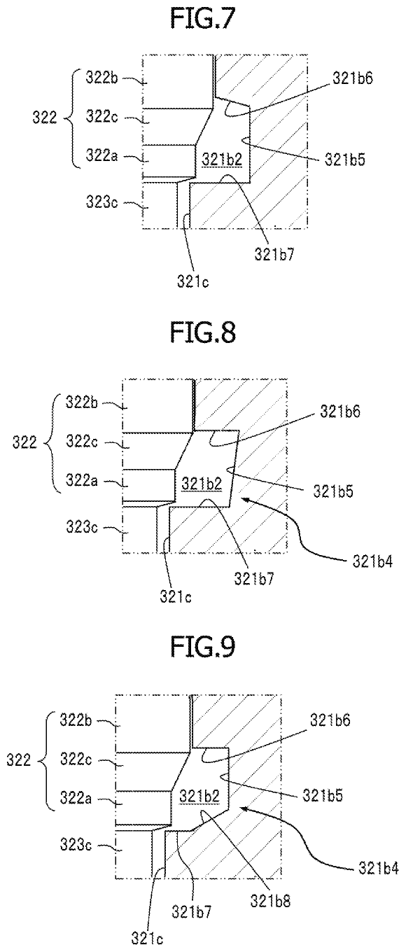

FIGS. 5 to 9 illustrate modified examples of the second embodiment of the control valve 300. As illustrated in FIG. 5, the tapered face 322c of the valve body 322 may be formed such that the diameter thereof increases from the peripheral edge of the tip (inclined surface 322a1) of the valve portion 322a to the partition portion 322b. As illustrated in FIGS. 6 to 9, the connecting surface 321b6 and bottom surface 321b5 of the recess 321b4 of the second pressure application chamber 321b2 may be formed as an inclined surface, or alternatively, the bottom surface 321b5 and extending surface 321b7 of the recess 321b4 may be connected by an inclined surface 321b8. It should be noted that the modified examples illustrated in FIGS. 6 to 9 may also be applicable to the first embodiment of the control valve 300.

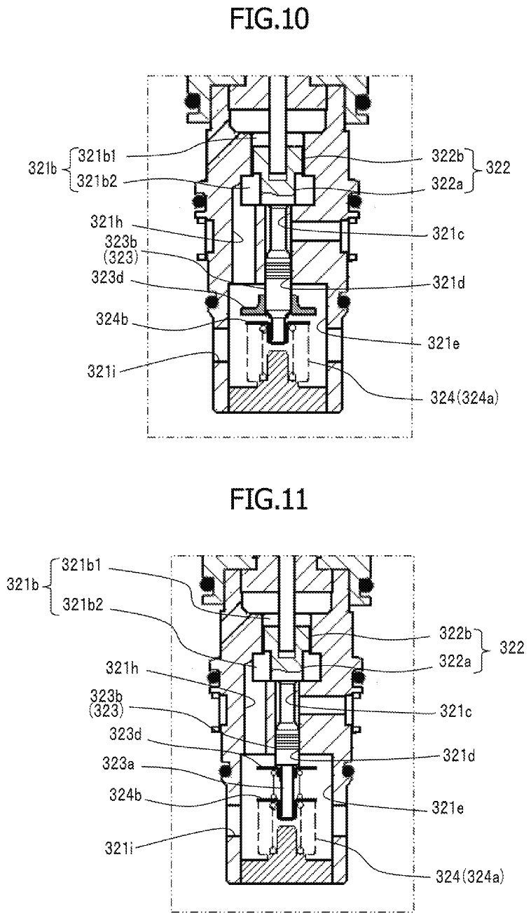

Next, a third embodiment of the control valve 300 will be described with reference to FIG. 10. The same elements as those of the first embodiment are denoted by the same reference symbols, and different elements will be mainly described.

As illustrated in FIG. 10, in the third embodiment, the pressure sensing rod 323 has a receiving portion 323d that receives the refrigerant flow flowing from the communication hole 321h into the pressure sensing chamber 321e. The receiving portion 323d is press-fitted and secured to the support portion 323b of the pressure sensing rod 323, for example, and is disposed between the opening end of the communication hole 321h on a side of the pressure sensing chamber 321e and the pressure sensing member 324 in the axial direction of the valve body 322. Preferably, at least a part of the receiving portion 323d may be arranged so as to face the opening end of the communication hole 321h on the side of the pressure sensing chamber 321e. As described above, the communication hole 321h is formed to be parallel to the insertion hole 321d (that is, the axis of the valve body 322), and the opening end of the communication hole 321h on the side of the pressure sensing chamber 321e is open to an upper surface of the pressure sensing chamber 321e. Thus, when the valve portion 322a opens the valve hole 321c, the refrigerant flow flowing into the pressure sensing chamber 321e from the opening end of the communication hole 321h on the side of the pressure sensing chamber 321e flows in a direction in which the pressure sensing member 324 (bellows 324a) contracts. Thus, the dynamic pressure of the refrigerant flow acts on the receiving portion 323d in the valve closing direction (the direction in which the bellows 324a contracts) of the valve body 322. Thus, it is possible to reduce the effects of dynamic pressure of the refrigerant flow in the valve chamber 321b acting in the valve opening direction of the valve body 322. As illustrated in FIG. 11, it may be configured so that the receiving portion 323d is attached to the tip portion 323a of the pressure sensing rod 323, and the compression coil spring 325 disposed between the receiving portion 323d and the first end member 324b of the pressure sensing member 324 presses and holds the receiving portion 323d at the end portion of the support portion 323b.

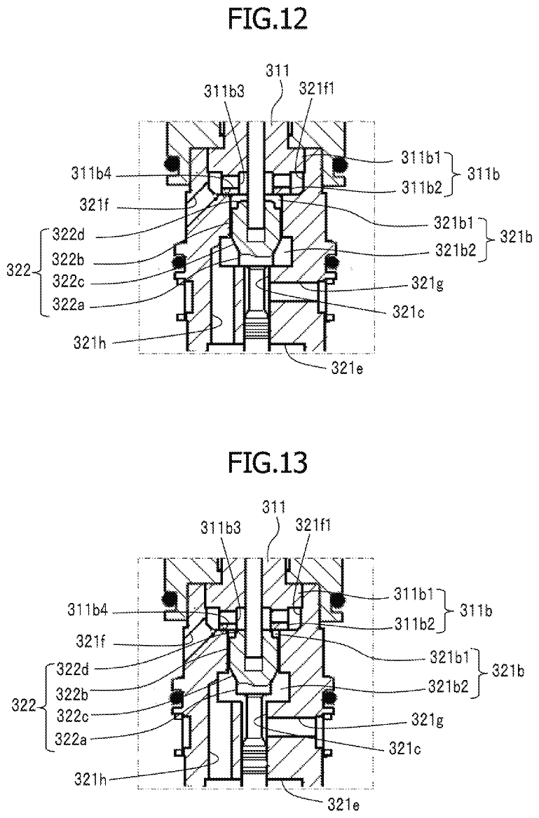

Next, a fourth embodiment of the control valve 300 will be described with reference to FIGS. 12 and 13. The same elements as those of the first embodiment are denoted by the same reference symbols, and different elements will be mainly described.

As illustrated in FIG. 12, in the fourth embodiment, the larger diameter portion 311b of the fixed core 311 has a fit portion 311b1 fitted to the fitting hole 321a of the valve housing 321, and a tip portion 311b2 having a smaller diameter than that of the fit portion 311b1. The tip surface of the tip portion 311b2 is in contact with a bottom surface of the fitting hole 321a, and an annular space 321f1 is formed between an outer peripheral surface of the tip portion 311b2 and an inner peripheral surface of the fitting hole 321a. The annular space 321f1 communicates with the suction chamber 141 through the communication hole 321f and the pressure introduction passage 147.

In the tip surface of the larger diameter portion 311b (tip portion 311b2) of the fixed core 311, a second valve hole 311b3 arranged on the same axis as the valve hole 321c is formed. The second valve hole 311b3 communicates with the valve chamber 321b and communicates with the annular space 321f1 through the communication hole 311b4 penetrating the tip portion 311b2 in the radial direction.

In the fourth embodiment, the valve body 322 includes: the valve portion 322a that adjusts the opening degree of the valve hole 321c; the partition portion 322b formed to have a larger diameter than that of the valve portion 322a; the tapered face 322c having the diameter increasing from the valve portion 322a to the partition portion 322b; and a second valve portion 322d arranged opposite the valve portion 322a across the partition portion 322b, the second valve portion 322d adjusting the opening degree of the second valve hole 311b3. Similarly to the first embodiment, the partition portion 322b partitions the valve chamber 321b into the first pressure application chamber 321b1 on which the pressure in the suction chamber 141 mainly acts, the first pressure application chamber 321b1 being located on the side of the fitting hole 321a, and the second pressure application chamber 321b2 on which the pressure in the crank chamber 140 mainly acts, the second pressure application chamber 321b2 being located on the side of the valve hole 321c. Thus, the valve portion 322a is disposed in the second pressure application chamber 321b2, and the second valve portion 322d is disposed in the first pressure application chamber 321b1. The valve body 322 is configured so that, as illustrated in FIG. 12, when the valve portion 322a closes the valve hole 321c, the second valve portion 322d opens the second valve hole 311b3 to a maximum, and, as illustrated in FIG. 13, when the second valve portion 322d closes the second valve hole 311b3, the valve portion 322a opens the valve hole 321c to a maximum.

That is, in the control valve 300 according to the fourth embodiment, the communication hole 321i, the pressure sensing chamber 321e, the communication hole 321h, the valve chamber 321b (clearance G), the second valve hole 311b3, the communication hole 311b4, the annular space 321f1 and the communication hole 321f constitute a part of the second pressure relief passage, which is different from the pressure relief passage 146. The clearance G (not illustrated) formed between the outer peripheral surface of the partition portion 322b of the valve body 322 and the inner peripheral surface of the valve chamber 321b facing the outer peripheral surface constitutes the fixed throttle (fixed orifice) of the second pressure relief passage. The control valve 300 is configured so that the second pressure relief passage is closed when the valve portion 322a opens the valve hole 321c to a maximum, that is, when the pressure supply passage 145 opens to a maximum.

In the control valve 300 according to the present embodiment, when the operation of the air conditioning system stops, and accordingly, the energization of the coil 316 of the control valve 300 is turned off, the valve body 322 is forced to have the valve portion 322a open the valve hole 321c to a maximum by the biasing force of the compression coil spring 314 of the solenoid unit 310, and to have the second valve portion 322d to close the second valve hole 311b3. Thus, all of the discharged refrigerant which has flowed from the discharge chamber 142 into the control valve 300 through the pressure supply passage 145A flows (is supplied) into the crank chamber 140. Thus, even when the variable displacement compressor 100 is operated with a small discharge displacement immediately before stop, for example, it is possible to reliably increase the pressure in the crank chamber 140 to achieve a state in which the discharge displacement of the variable displacement compressor 100 at the time of stopping is reduced, or is preferably minimal. Furthermore, since all of oil contained in the discharged refrigerant, which has flowed into the control valve 300, is also supplied to the crank chamber 140, it is possible to sufficiently lubricate every sliding portion of the crank chamber 140.

While the second valve hole 311b3 is closed by the second valve portion 322d, a pressure difference between the crank chamber 140 and the suction chamber 141 causes a force in a direction in which the second valve portion 322d closes the second valve hole 311b3, applied to the valve body 322. This requires a greater force for moving the valve body 322 in a direction in which the second valve portion 322d opens the second valve hole 311b3 from a state in which the second valve portion 322d closes the second valve hole 311b3, compared with the abovementioned first embodiment, or the like. Thus, in the fourth embodiment, the outer diameter of the second valve portion 322d (and the second valve hole 311b3) is set to be smaller than that of the partition portion 322b so as to decrease the area on which the pressure difference between the crank chamber 140 and the suction chamber 141 acts, that is, in this case, the area of the second valve portion 322d that closes the second valve hole 311b3 (the pressure receiving area receiving the pressure in the suction chamber 141). Thus, it is possible to rapidly transfer the state of the control valve 300 from a state in which the second valve hole 311b3 is closed by the second valve portion 322d to an operating state in which the valve portion 322a adjusts the opening degree of the valve hole 321c.

Although, in the foregoing, a case in which the present invention is applied to a swash plate type variable displacement compressor using a crank chamber as a controlled pressure chamber for a capacity control is described, this is not limited thereto, and the present invention may be widely applicable to variable displacement compressors in which the displacement is variably controlled by changing the pressure in a pressure chamber.

Furthermore, the present invention is not limited to the embodiments described above, and further modifications and changes can be made based on the technical concept of the present invention.

### REFERENCE SYMBOL LIST

100 Variable displacement compressor
101a Cylinder bore
111 Swash plate
136 Piston
140 Crank chamber (controlled pressure chamber)
141 Suction chamber
142 Discharge chamber
145 Pressure supply passage
147 Pressure introduction passage
300 Control valve
310 Solenoid unit
311 Fixed core
311b Larger diameter portion of fixed core
311b3 Second valve hole
312 Movable core
313 Solenoid rod
314 Compression coil spring
320 Valve unit
321 Valve housing
321a Fitting hole
321b Valve chamber
321b1 First pressure application chamber
321b2 Second pressure application chamber
321b4 Recess
321c Valve hole
321d Installation hole
321e Pressure sensing chamber
321f-321i Communication hole
322 Valve body
322a Valve portion
322b Partition portion
322c Tapered face
322d Second valve portion
323 Pressure sensing rod
323d Receiving portion
324 Pressure sensing member

1. A control valve for a variable displacement compressor, for use to adjust a pressure in a controlled pressure chamber in the variable displacement compressor that includes a suction chamber into which a refrigerant before being compressed is introduced, a compression section that draws and compresses the refrigerant in the suction chamber, a discharge chamber into which the compressed refrigerant compressed by the compression section is discharged, and the controlled pressure chamber, in which a state of the compression section changes in accordance with a pressure in the controlled pressure chamber to change a discharge displacement,
the control valve comprising:
a valve body having a valve portion that adjusts an opening degree of a valve hole constituting a part of a pressure supply passage for supplying the refrigerant in the discharge chamber to the controlled pressure chamber; and
a valve chamber that accommodates the valve body, the valve chamber consisting a part of a pressure relief passage through which the refrigerant in the controlled pressure chamber flows toward the suction chamber when the valve portion of the valve body closes the valve hole, and consisting a part of the pressure supply passage when the valve portion of the valve body opens the valve hole,
wherein the valve body further has a partition portion having a larger diameter than that of the valve portion and partitioning the valve chamber into a first pressure application chamber on which a pressure in the suction chamber mainly acts, and a second pressure application chamber on which the pressure in the controlled pressure chamber mainly acts and into which the refrigerant in the discharge chamber flows when the valve portion of the valve body opens the valve hole,
wherein a clearance constituting a fixed orifice of the pressure relief passage is formed between an outer peripheral surface of the partition portion of the valve body and an inner peripheral surface of the valve chamber facing the outer peripheral surface,
wherein the second pressure application chamber is formed to have a larger inner diameter than that of the inner peripheral surface of the valve chamber facing the outer peripheral surface of the partition portion of the valve body.

2. The control valve for the variable displacement compressor, according to claim 1, wherein the second pressure application chamber has a recess recessed radially outward with respect to the inner peripheral surface of the valve chamber facing the outer peripheral surface of the partition portion of the valve body.

3. The control valve for the variable displacement compressor, according to claim 1, wherein the valve body has a tapered face having a diameter increasing from the valve portion to the partition portion.

4. The control valve for the variable displacement compressor, according to claim 3, wherein an end portion of the tapered face on a side of the partition portion is located in the second pressure application chamber.

5. The control valve for the variable displacement compressor, according to claim 1, further comprising:
a solenoid unit that applies, to the valve body, an electromagnetic force in a direction in which the valve portion closes the valve hole; and
a pressure sensing member that expands and contracts in response to the pressure in the suction chamber, the pressure sensing member expanding as the pressure in the suction chamber decreases, to make a biasing force in a direction in which the valve portion opens the valve hole, act on the valve body via a pressure sensing rod integrally formed with the valve body.

6. The control valve for the variable displacement compressor, according to claim 5, further comprising a pressure sensing chamber that accommodates the pressure sensing member, the pressure chamber being arranged closer to the controlled pressure chamber with respect to the valve chamber, the pressure sensing chamber constituting a part of the pressure relief passage when the valve portion of the valve body closes the valve hole, and constituting a part of the pressure supply passage when the valve portion of the valve body opens the valve hole,
wherein the valve chamber and the pressure sensing chamber communicate through at least one communication hole,
wherein an opening end of the at least one communication hole on a side of the valve chamber is open to a region in the second pressure application chamber, the region being radially outward the inner peripheral surface of the valve chamber facing the outer peripheral surface of the partition portion of the valve body.

7. The control valve for the variable displacement compressor, according to claim 6,
wherein the at least one communication hole is formed to be substantially parallel to an axis of the valve body,
wherein the pressure sensing rod has a receiving portion that is arranged between an opening end of the at least one communication hole on a side of the pressure sensing chamber and the pressure sensing member, and that receives a refrigerant flow flowing from the opening end of the at least one communication hole on the side of the pressure sensing chamber into the pressure sensing chamber.

8. The control valve for the variable displacement compressor, according to claim 1, wherein the valve body further has a second valve portion that closes a second valve hole constituting a part of the pressure relief passage when the valve portion opens the valve hole to a maximum.

9. A variable displacement compressor comprising:
a suction chamber into which a refrigerant before being compressed is introduced;
a compression section that draws and compresses the refrigerant in the suction chamber;
a discharge chamber into which the compressed refrigerant compressed by the compression section is discharged;
a controlled pressure chamber that changes a state of the compression section in accordance with an internal pressure, to change a discharge displacement; and
a control valve according to claim 1.

10. The control valve for the variable displacement compressor, according to claim 2, wherein the valve body has a tapered face having a diameter increasing from the valve portion to the partition portion.

11. The control valve for the variable displacement compressor, according to claim 2, further comprising:
a solenoid unit that applies, to the valve body, an electromagnetic force in a direction in which the valve portion closes the valve hole; and
a pressure sensing member that expands and contracts in response to the pressure in the suction chamber, the pressure sensing member expanding as the pressure in the suction chamber decreases, to make a biasing force in a direction in which the valve portion opens the valve hole, act on the valve body via a pressure sensing rod integrally formed with the valve body.

12. The control valve for the variable displacement compressor, according to claim 3, further comprising:
a solenoid unit that applies, to the valve body, an electromagnetic force in a direction in which the valve portion closes the valve hole; and
a pressure sensing member that expands and contracts in response to the pressure in the suction chamber, the pressure sensing member expanding as the pressure in the suction chamber decreases, to make a biasing force in a direction in which the valve portion opens the valve hole, act on the valve body via a pressure sensing rod integrally formed with the valve body.

13. The control valve for the variable displacement compressor, according to claim 4, further comprising:
a solenoid unit that applies, to the valve body, an electromagnetic force in a direction in which the valve portion closes the valve hole; and
a pressure sensing member that expands and contracts in response to the pressure in the suction chamber, the pressure sensing member expanding as the pressure in the suction chamber decreases, to make a biasing force in a direction in which the valve portion opens the valve hole, act on the valve body via a pressure sensing rod integrally formed with the valve body.

14. The control valve for the variable displacement compressor, according to claim 2, wherein the valve body further has a second valve portion that closes a second valve hole constituting a part of the pressure relief passage when the valve portion opens the valve hole to a maximum.

15. The control valve for the variable displacement compressor, according to claim 3, wherein the valve body further has a second valve portion that closes a second valve hole constituting a part of the pressure relief passage when the valve portion opens the valve hole to a maximum.

16. The control valve for the variable displacement compressor, according to claim 4, wherein the valve body further has a second valve portion that closes a second valve hole constituting a part of the pressure relief passage when the valve portion opens the valve hole to a maximum.

17. The control valve for the variable displacement compressor, according to claim 5, wherein the valve body further has a second valve portion that closes a second valve hole constituting a part of the pressure relief passage when the valve portion opens the valve hole to a maximum.

18. The control valve for the variable displacement compressor, according to claim 6, wherein the valve body further has a second valve portion that closes a second valve hole constituting a part of the pressure relief passage when the valve portion opens the valve hole to a maximum.

19. The control valve for the variable displacement compressor, according to claim 7, wherein the valve body further has a second valve portion that closes a second valve hole constituting a part of the pressure relief passage when the valve portion opens the valve hole to a maximum.

20. A variable displacement compressor comprising:
a suction chamber into which a refrigerant before being compressed is introduced;
a compression section that draws and compresses the refrigerant in the suction chamber;
a discharge chamber into which the compressed refrigerant compressed by the compression section is discharged;
a controlled pressure chamber that changes a state of the compression section in accordance with an internal pressure, to change a discharge displacement; and
a control valve according to claim 7.
